(19) United States
(12) Patent Application Publication
(10) Pub. No.: US 2026/0065647 A1
(43) Pub. Date: Mar. 5, 2026

(54) AUTOMATIC BIAS RELATED DATASET CREATION FOR MACHINE LEARNING TRAINING

(71) Applicant: AUTOBRAINS TECHNOLOGIES LTD, Tel Aviv-Yafo (IL)

(72) Inventors: Igal RAICHELGAUZ, Tel Aviv (IL); Tomer COHEN, Tel Aviv-Yafo (IL); Hadas ELKABIR, Tel Aviv-Yafo (IL)

(73) Assignee: AUTOBRAINS TECHNOLOGIES LTD, Tel Aviv-Yafo (IL)

(21) Appl. No.: 18/818,627

(22) Filed: Aug. 29, 2024

Related U.S. Application Data
(63) Continuation of application No. 18/818,612, filed on Aug. 29, 2024.

(51) Int. Cl. G06V 10/774; G06V 10/82; G06V 20/56

(52) U.S. Cl. CPC G06V 10/774; G06V 10/82; G06V 20/56

(57) ABSTRACT

A method of automatic bias related dataset creation for machine learning training, the method includes identifying, via a self-supervised learning process, a sensed information unit that is classification biased as it exhibits a combination of features, the sensed information unit is of a dataset associated with captured data in a road environment; automatically artificially creating a set of sensed information units exhibits only one or only some features of the combination of features; and adding the automatically artificially created set to the dataset to provide an updated data set in association with the identified classification biased sensed information unit for training a machine learning process with the updated dataset to provide a trained machine learning process that identifies each of the combination of features as a separate feature for classification.

### BACKGROUND

Vehicles with autonomous driving capabilities and/or driver assistance capabilities are required to process in real time information regarding one or more road elements and to respond accordingly.

There is a growing need to improve the processing of information regarding road elements.

### SUMMARY

A method, system and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1 illustrates an example of a vehicle;

FIG. 2 illustrates an example of a method;

FIG. 3 illustrates an example of a method;

FIG. 4 illustrates an example of a method;

FIG. 5 illustrates an example of a method; and

FIGS. 6-8 illustrate examples of biased sensed information units.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

According to an embodiment, there is provided a method that is capable of identifying bias and to remove the bias by generating artificially generated sensed information units (for removing the bias) to provide a dataset that include one or more biased sensed information units and the artificially generated sensed information units.

According to an embodiment the artificially generated sensed information unit may be generated in any manner-for example by a machine learning sensed information generator—such as diffusion models (also known as diffusion probabilistic models or score-based generative models), a generative adversarial network (GAN), and the like.

According to an embodiment, the dataset is used to train a machine learning process to provide a trained machine learning process to be used in classification—while overcoming the bias.

According to an embodiment, a biased sensed information unit captures a combination of a first road element and a second road element. A bias impacted classification process would conclude that the combination is essential—that the first road element may not exist without the second road element. A road element is an elements associated with a road—for example is expected to appear in a sensed information unit of a road and its surroundings—for example an object, a road segment, and the like—a pedestrian, a vehicle, a road marking, a traffic sign, a traffic light, and the like.

According to an embodiment, the method artificially generates generating artificially generated sensed information units, whereas an artificially generated sensed information unit captures only the first road element or only the second road element. According to an embodiment, the artificially generated sensed information unit may capture a different combination of the elements.

According to an embodiment, the dataset used to train the machine learning process to provide a trained machine learning process to be used in classification—while overcoming the bias—so that the trained machine learning process may treat each one of the first and second elements as a separate item of classification.

According to an embodiment, a biased sensed information unit exhibits a combination of features.

According to an embodiment, the features may be sensed information unit parameters such as illumination conditions, partial occlusion of a road element, unclear regions of a road element (for example due to weather conditions such as fog, light source position and/or angle, smoke, confetti, and the like), difference in illumination of different environment parts, and the like.

According to an embodiment, the features relate to one or more road elements captured in the sensed information unit—for example a road element that is partially obscured and also being illuminated in a manner that differs from the surroundings of the road element—for example—a road element that is significantly brighter than its surroundings, and the like.

According to an embodiment, the method artificially generates generating artificially generated sensed information units, whereas an artificially generated sensed information unit that does not exhibit the combination of the features that lead to the bias.

According to an embodiment, the dataset used to train the machine learning process to provide a trained machine learning process to be used in classification—while overcoming the bias—so that the trained machine learning process may separately treat each feature.

According to an embodiment, the solution overcomes bias and is capable of providing a trained machine learning process that may successfully classify road elements that appear in a large variety of sensed information unit.

According to an embodiment, the detection of the bias is done in an unsupervised manner—which is highly effective—and may be performed during inference and/or during multiple points in time—and may lead to retrain the machine learning process—to overcome bias that is detected over time.

According to an embodiment, the detection of bias is executed in an effective and resource saving manner—by searching for outliers of representations of sensed information units—and using the sensed information units associated with the outliers as candidates for biased sensed information units. According to an embodiment, sensed information units that are not outliers (and are included in clusters) are not searched for bias.

According to an embodiment, the method allows using biased sensed information units that may be acquired under harsh conditions (partial occlusions or any one of the mentioned above sensed information unit parameters)—and being able to accurately classify road elements captured under such harsh conditions—and also when captured under better conditions.

According to an embodiment, the dataset once updated with the artificially generated sensed information unit provides a wide coverage of road elements and sensed information unit capture conditions (for example—day, night, dawn, clear weather, sun glare, rain, snow, fog, city, highway, traffic jam, etc.).

According to an embodiment, the training process may be executed in two loops without creating bias—for example learning from a small set of biased sensed information units in order to minimize the error of a large set of sensed information units that are not biased—without creating bias.

For example—the small set may include pedestrians having an occluded, or hidden body part(s), while the larger sets includes pedestrians that are not occluded. According to an embodiment, artificially generated sensed information units may add occluded body parts and/or may separately classify different body parts.

According to an embodiment, the method includes artificially generating biased sensed information unit (for example—occluding a body part)—and training the machine learning process to detect a pedestrian even if partially occluded.

According to an embodiment, the method allows the trained machine learning process to correctly identify road element even in case where is receives, during inference, a biased sensed information unit.

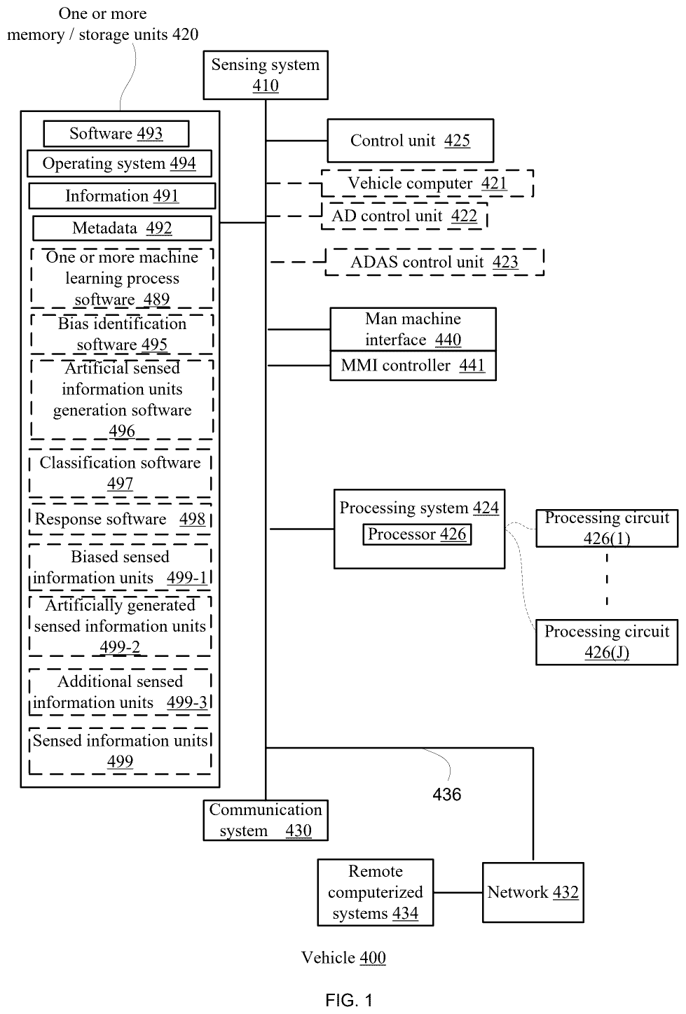

FIG. 1 illustrates an example of a vehicle 400.

Vehicle 400 includes a man machine interface 440 having or being in communication with man machine interface (MMI) controller 441, a communication system 430, one or more memory and/or storage units 420, a processing system 424 including processor 426. The communication system 430, the one or more memory and/or storage units 420, and the processing system 424 may belong to a computerized system of vehicle 400. The computerized system may be a server, a laptop, a desktop or any other computer and may include or be in communication with a sensing unit and/or a controller.

According to an embodiment, vehicle 400 is in communication with network 432 and one or more other remote computerized systems 434 that are in communication with network 432. An example of a remote computerized system is a server or one or more computers having access to a storage system that stores items related to one or more portions of one or more groups of neural networks—at least some of which are not currently stored in the vehicle.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as sensing system 410, man machine interface 440, control unit 425, vehicle computer 421, autonomous driving control unit 422 (denoted AD control unit), advanced driver assistance system (ADAS) control unit 423 (denoted ADAS control unit), and the like.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the vehicle. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 494, information 491 such as sensed information units 499 (including biased sensed information units 499-1, artificially generated sensed information units 499-2, additional sensed information units 499-3), metadata 492, and software 493 such as bias identification software 495, artificial sensed information units generation software 496, classification software 497, response software 498, one or more machine learning process software 489) for executing at least one of method 200 and/or method 300 and/or method 600 and/or method 700. The response software 498 is for responding to a classification decision—for example by generating a driving related output.

The control unit 425 may cooperate with ADAS control unit 423 and/or with AD control unit 422 and/or may control or communicate with other vehicle components—including vehicle computer.

The ADAS control unit 423 is configured to control ADAS operations.

The AD control unit 422 is configured to control autonomous driving of the autonomous vehicle.

The vehicle computer 421 is configured to control the operation of the vehicle—especially controlling the engine, the transmission, and any other vehicle system or component.

The vehicle computer 421 may be in communication with an engine control module, a transmission control module, a powertrain control module, and the like.

The sensing system 410 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 410 is configured to output one or more sensed information units (SIUs).

Control unit 425 is configured to control the operation of the sensing system 410, and/or the one or more memory and/or storage units 420 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 alone or in combination of any other unit illustrated above, is configured to perform, while executing software or method 200.

According to an embodiment, processing system 424 alone or in combination of any other unit illustrated above, is configured to execute at least one step of at least one method of methods 200, 300, 600 and 700.

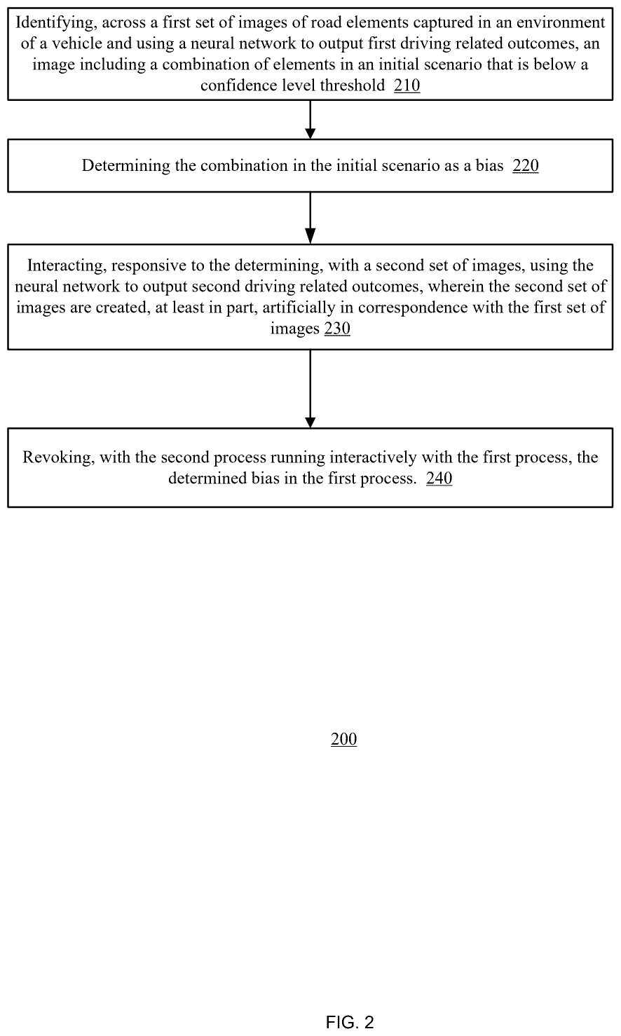

FIG. 2 illustrates an example of method 200 of decorrelated topic based representation of road elements for classification.

According to an embodiment, method 200 includes step 210 of identifying, across a first set of images of road elements captured in an environment of a vehicle and using a neural network to output first driving related outcomes, an image including a combination of elements in an initial scenario that is below a confidence level threshold. The initial scenario that is below a confidence level threshold in the sense that a classification decision related to image is below a confidence level—and/or that a representation of the sensed information unit is an outlier.

According to an embodiment, step 210 is followed by step 220 of determining the combination in the initial scenario as a bias. The determination can be done automatically.

According to an embodiment the determination of the bias is based on at least one criteria such as:
A. Whether a previously processed and/or classified sensed information unit captured only one of the road elements (may indicate that there is no bias—or that the bias probability is lower than in the cases that either one of the road elements were previously captured in a previously processed and/or classified sensed information unit).
B. Whether the first road element and the second road element are spaced apart from each other-more spacing may reduce the chances of bias.
C. Whether a segmentation process separates between the first road element and the second road element (to be included in separate segments)—if independently segmented—the chances of bias are lower than when both road elements are segmented to the same segment.
D. Whether one road element partially obscures another road element—whereas the partially obscuring increases the chances of bias.

According to an embodiment, step 220 includes determining of the combination in the initial scenario as the bias comprises determining a bias probability. According to an embodiment the bias probability is compared to a probability threshold that once exceeded-a bias is found. The probability threshold may be set in any manner—for example based on sensitivity to classification errors resulting from bias, resources allocated to bias detection, number of outliers that are similar to each other (more such outliers may increase the probability threshold), and the like.

According to an embodiment, the determining of the probability is based on whether any one of the elements of the combination was previously individually classified as an element.

According to an embodiment, the determining of the probability is based on whether the elements of the combination are separated from each other by segmentation.

According to an embodiment, the determining of the probability is based on whether one element of the combination partially obscures another element of the combination

According to an embodiment, step 220 is followed by step 230 of interacting, responsive to the determining, with a second set of images, using the neural network to output second driving related outcomes, wherein the second set of images are created, at least in part, artificially in correspondence with the first set of images and each includes at least one of: only one element of the combination of elements, or a different combination of the elements, to contain a sample combination of image samples based on the determined bias.

According to an embodiment, step 230 is followed by step 240 of revoking, with the second process running interactively with the first process, the determined bias in the first process, by interacting with the first process using the second driving related outcomes of the second process.

According to an embodiment, the revoking is inherent—as the addition of the second set images will allow the neural network to properly overcome the bias.

According to an embodiment, method 200 also includes jumping to step 210 and determining the combination in another scenario as another bias.

According to an embodiment, the first set of images includes images sensed by sensors associated with one or more vehicles.

According to an embodiment, the first set of images well exceeds the second set of images.

According to an embodiment the second set of images includes images associated with representations that are not outliers.

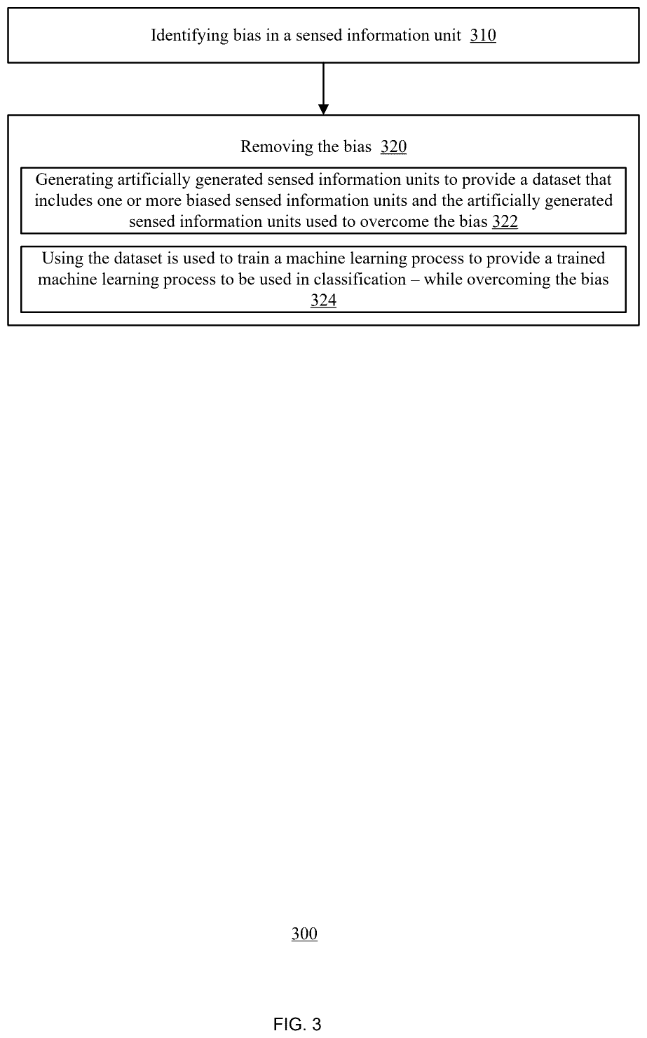

FIG. 3 illustrates method 300 for overcoming bias related to classification.

According to an embodiment, method 300 includes step 310 of identifying bias in a sensed information unit.

According to an embodiment, step 310 includes calculating bias probability.

According to an embodiment the bias probability is based on at least one criteria such as:
A. Whether a previously processed and/or classified sensed information unit captured only one of the road elements (may indicate that there is no bias—or that the bias probability is lower than in the cases that either one of the road elements were previously captured in a previously processed and/or classified sensed information unit).
B. Whether the first road element and the second road element are spaced apart from each other—more spacing may reduce the chances of bias.
C. Whether a segmentation process separates between the first road element and the second road element (to be included in separate segments)—if independently segmented—the chances of bias are lower than when both road elements are segmented to the same segment.
D. Whether one road element partially obscures another road element-whereas the partially obscuring increases the chances of bias.

According to an embodiment, step 310 is followed by step 320 removing the bias.

According to an embodiment, step 320 includes step 322 of generating artificially generated sensed information units to provide a dataset that includes one or more biased sensed information units and the artificially generated sensed information units (such as artificially generated sensed information units 499-2) used to overcome the bias. The dataset may also include sensed information units that were not previously identified as including bias. The sensed information units that were not previously identified as including bias (such as additional sensed information units 499-3) and the one or more biased sensed information unit (such as bias sensed information unit 499-1) may belong to an initial dataset that was updated during step 320 by the addition of the generating artificially generated sensed information units.

According to an embodiment, step 320 also includes step 324 of using the dataset is used to train a machine learning process to provide a trained machine learning process to be used in classification—while overcoming the bias.

According to an embodiment, a biased sensed information unit captures a combination of a first road element and a second road element. A bias impacted classification process would conclude that the combination is essential—that the first road element may not exist without the second road element.

According to an embodiment, an artificially generated sensed information unit captures only the first road element or only the second road element. According to an embodiment, the artificially generated sensed information unit captures a different combination of the elements. The different combination may differ from the combination suspected as being a bias by a least one of a spatial relationship between the elements of the combination, relative size of at least one element of the combination, an amount (if any) of overlap or obscuring of at least one of the elements, illumination conditions, and the like.

According to an embodiment, the dataset used to train the machine learning process provides a trained machine learning process to be used in classification—while overcoming the bias—so that the trained machine learning process may treat each one of the first and second elements as a separate item of classification.

According to an embodiment, a biased sensed information unit exhibits a combination of features—and step 310 includes detecting the combination of features as bias.

According to an embodiment, the features are sensed information unit parameters such as illumination conditions, partial occlusion of a road element, unclear regions of a road element (for example due to weather conditions such as fog, light source position and/or angle, smoke, confetti, and the like), difference in illumination of different environment parts, and the like.

According to an embodiment, the features relate to one or more road elements captured in the sensed information unit—for example a road element that is partially obscured and also being illuminated in a manner that differs from the surroundings of the road element—for example—a road element that is significantly brighter than its surroundings, and the like.

According to an embodiment, step 322 includes generating artificially generated sensed information units in which an artificially generated sensed information unit that does not exhibit the combination of the features that lead to the bias.

According to an embodiment, step 324 provides a trained machine learning process to be used in classification—while overcoming the bias—so that the trained machine learning process may separately treat each feature.

According to an embodiment, method 600 and/or method 300 and/or method 200 overcome bias and is capable to provide a trained machine learning process that may successfully classify road elements that appear in a large variety of sensed information unit.

According to an embodiment, step 310 is done in an unsupervised manner—which is highly effective—and may be performed during inference and/or during multiple points in time—and may lead to retrain the machine learning process—to overcome bias that is detected over time.

According to an embodiment, step 310 is executed in an effective and resource saving manner—by searching for outliers of representations of sensed information units—and using the sensed information units associated with the outliers as candidates for biased sensed information units. According to an embodiment, sensed information units that are not outliers (and are included in clusters) are not searched for bias.

According to an embodiment, method 600 and/or method 300 and/or method 200 allow using biased sensed information units that may be acquired under harsh conditions (partial occlusions or any one of the mentioned above sensed information unit parameters)—and being able to accurately classify road elements captured under such harsh conditions—and also when captured under better conditions.

According to an embodiment, the dataset once updated with the artificially generated sensed information unit provides a wide coverage of road elements and sensed information unit capture conditions (for example—day, night, dawn, clear weather, sun glare, rain, snow, fog, city, highway, traffic jam, etc.).

According to an embodiment, step 324 may be executed in two loops without creating bias—for example learning from a small set of biased sensed information units in order to minimize the error of a large set of sensed information units that are not biased—without creating bias. For example—the small set may include pedestrians having an occluded, or hidden body part(s), while the larger sets includes pedestrians that are not occluded. According to an embodiment, artificially generated sensed information units may add occluded body parts and/or may separately classify different body parts.

According to an embodiment, step 322 includes artificially generating biased sensed information unit (for example—occluding a body part)—and training the machine learning process to detect a pedestrian even if partially occluded.

According to an embodiment method 600 and/or method 300 and/or method 200 allow the trained machine learning process to correctly identify road element even in case where is receives, during inference, a biased sensed information unit.

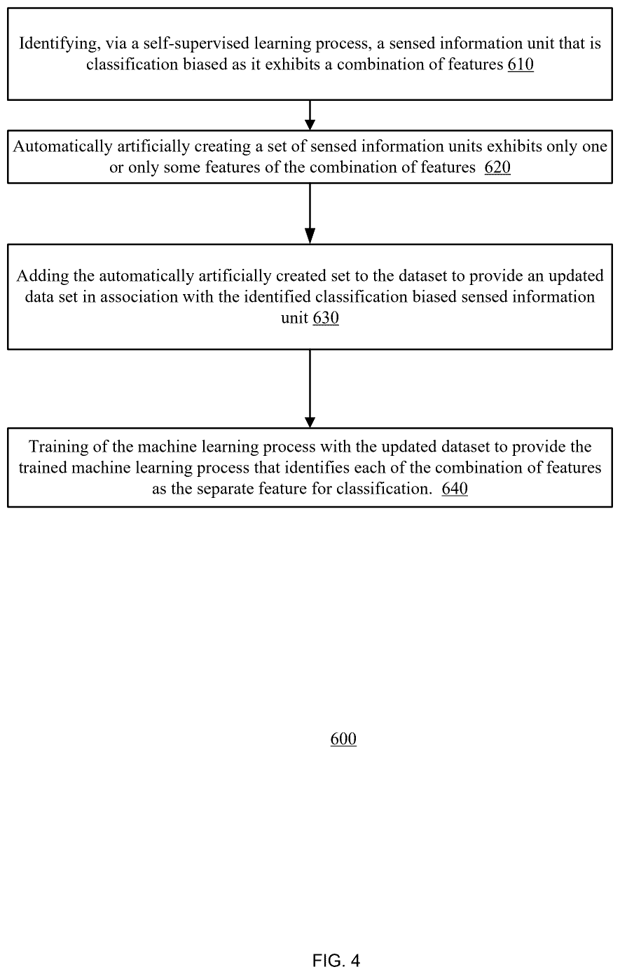

FIG. 4 illustrates an example of method 600 of automatic bias related dataset creation for machine learning training.

According to an embodiment, method 600 includes step 610 of identifying, via a self-supervised learning process, a sensed information unit that is classification biased as it exhibits a combination of features, the sensed information unit is of a dataset associated with captured data in a road environment.

According to an embodiment, step 610 is followed by step 620 of automatically artificially creating a set of sensed information units exhibits only one or only some features of the combination of features.

According to an embodiment, step 620 is followed by step 630 of adding the automatically artificially created set to the dataset to provide an updated data set in association with the identified classification biased sensed information unit for training a machine learning process with the updated dataset to provide a trained machine learning process that identifies each of the combination of features as a separate feature for classification.

According to an embodiment, step 630 is followed by step 640 of training of the machine learning process with the updated dataset to provide the trained machine learning process that identifies each of the combination of features as the separate feature for classification.

According to an embodiment, the combination of features capture a combination of a first element with a second element.

According to an embodiment, each of the automatically artificially created a set of sensed information units comprising at least one of: the first element, the second element, or a different combination of the first element and the second element.

According to an embodiment, the first element is at least a portion of a first road user, and the second element is at least a portion of a second road user.

According to an embodiment, the first element and the second element are at least a portion of a same road user.

According to an embodiment, the first element is captured with a first visual effect and the second element is captured with a second visual effect that differs from the first visual effect.

According to an embodiment, the combination of features involves different visual effects of a road user captured by the sensed information unit. The different visual effects include an illumination feature (strength, patterned illumination or un-patterned illumination, illumination spectrum) partial occlusion, focus, clarity of vision, and the like.

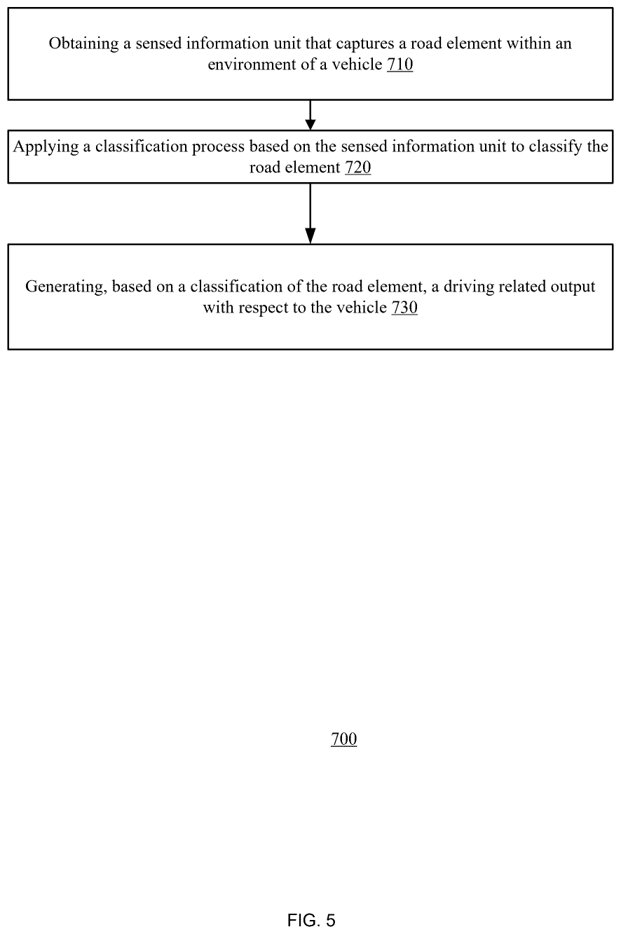

FIG. 5 illustrates an example of classification method 700.

According to an embodiment, method 700 includes step 710 of obtaining a sensed information unit that captures a road element within an environment of a vehicle.

According to an embodiment, step 710 is followed by step 720 of applying a classification process based on the sensed information unit to classify the road element.

According to an embodiment the classification process is executed by a neural network trained using any step of method 200 and/or any step of method 300 and/or any step of method 600.

According to an embodiment step 720 is followed by step 730 of generating, based on a classification of the road element, a driving related output with respect to the vehicle.

According to an embodiment, the driving related output includes at least one of:
A. An instruction executable by a man machine interface controller, to provide a recommendation to a driver regarding a navigation of the vehicle.
B. A request aimed to the man machine interface controller, to provide a recommendation to a driver regarding a navigation of the vehicle.
C. An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
D. A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
E. An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle or performing an autonomous braking operation or performing a lane maintenance operation of temporarily, during a short period, takeover the control of the vehicle, and the like.
F. A request aimed to a driver assistance control unit (such as but not limited to an ADAS control unit) of the vehicle to perform a driver assisting operation-such as suggesting to the driver a suggested path of progress, a suggested speed and/or acceleration and/or direction of the vehicle or performing an autonomous braking operation or performing a lane maintenance operation of temporarily, during a short period, takeover the control of the vehicle, and the like.
G. An instruction executable by a computer vehicle related to a manner of operation of any component of the vehicle such as brakes, engine, and the like.
H. A request sent to a computer vehicle related to a manner of operation of any component of the vehicle such as brakes, engine, and the like.
I. Information about the environment of the vehicle.
J. A prediction of a future path of the vehicle.
K. A prediction of a behavior of one or more road element.
L. An emergency alert.
M. A collision alert.

According to an embodiment, the method includes outputting and/or transmitting an/or storing and/or instructing to respond to and/or triggering a response to and/or controlling a response to and/or performing a respond to any of the driving related output listed above and/or below.

According to an embodiment, the method includes generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment—and/or in the environment with re to the vehicle, an operation and/or response in compliant with one or more levels of autonomous driving—such as L2, L2+, L2++, L3 or L4 autonomous driving.

The providing may include storing at a location accessible to another unit controller, transmitting the instructions to the other unit, sending an indication about the generation of the instructions to the other unit man machine interface controller.

According to an embodiment, the method may include outputting and/or transmitting an/or storing and/or instructing to respond to and/or triggering a response to and/or controlling a response to and/or performing a respond to any of the driving related output listed above and/or below.

Any combination of any step of any method illustrated in the application is provided.

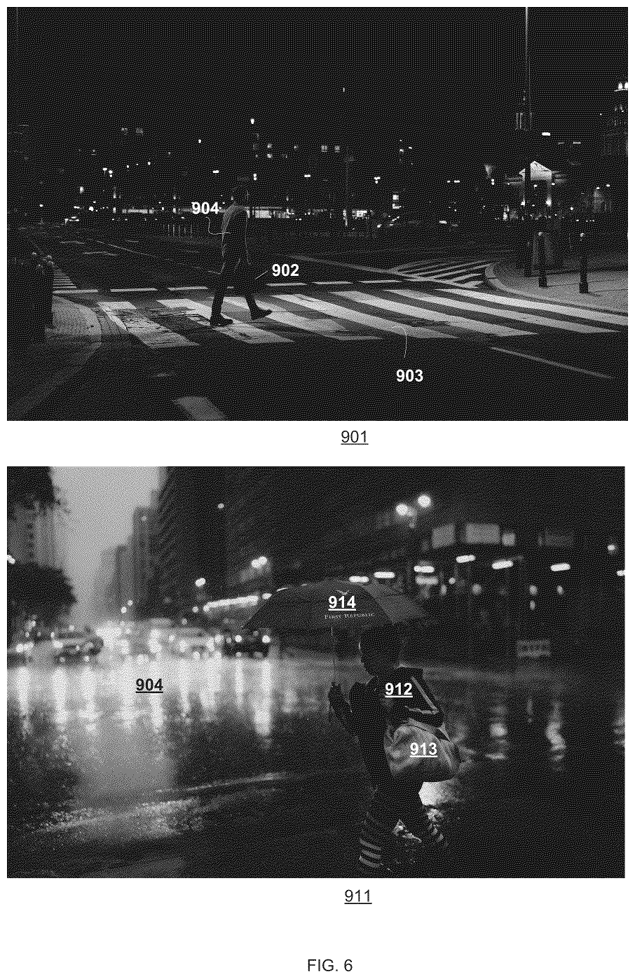

FIGS. 6-8 illustrate examples of sensed information units that may be deemed to be biased.

Image 901 of FIG. 6 illustrates a combination of a pedestrian 904 that is partially occluded by a bag 902 and is much darker than its surroundings 903. If this combination is deemed to be biased than artificially generated sensed information units that capture only the pedestrian or only the bag may be generated—and/or the pedestrian may be illuminated with a stronger illumination.

Image 911 of FIG. 6 illustrates a combination of a pedestrian 912 that is partially occluded by a bag 913 and carries a partially obscured umbrella 914—and is much darker than its surroundings 904. If this combination is deemed to be biased then artificially generated sensed information units that capture only the pedestrian or only the bag or only the umbrella may be generated—and/or the pedestrian may be illuminated with a stronger illumination.

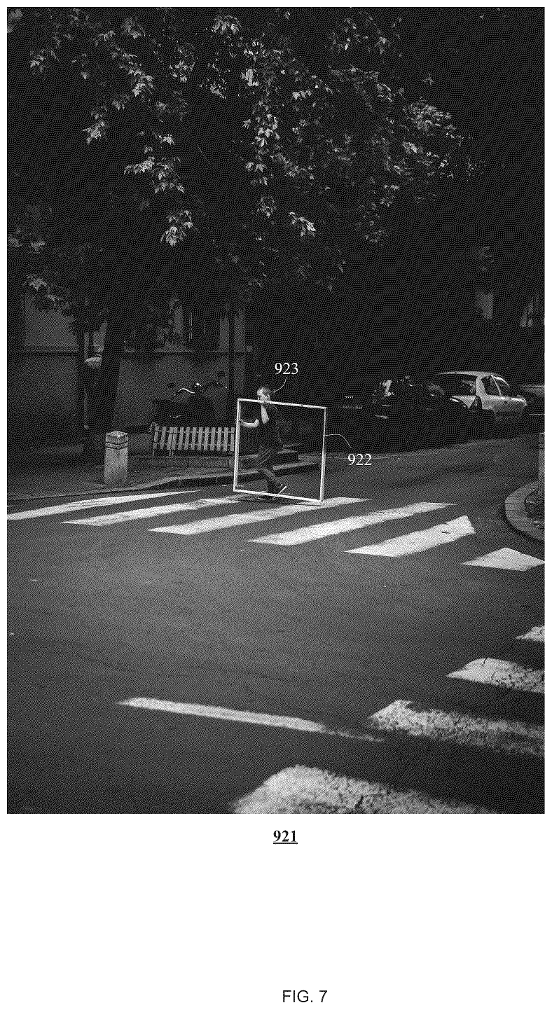

Image 921 of FIG. 7 illustrates a combination of a boy 923 carrying a frame 922 that partially obscured the boy. If this combination is deemed to be biased then artificially generated sensed information units that capture only the boy or only the frame may be generated.

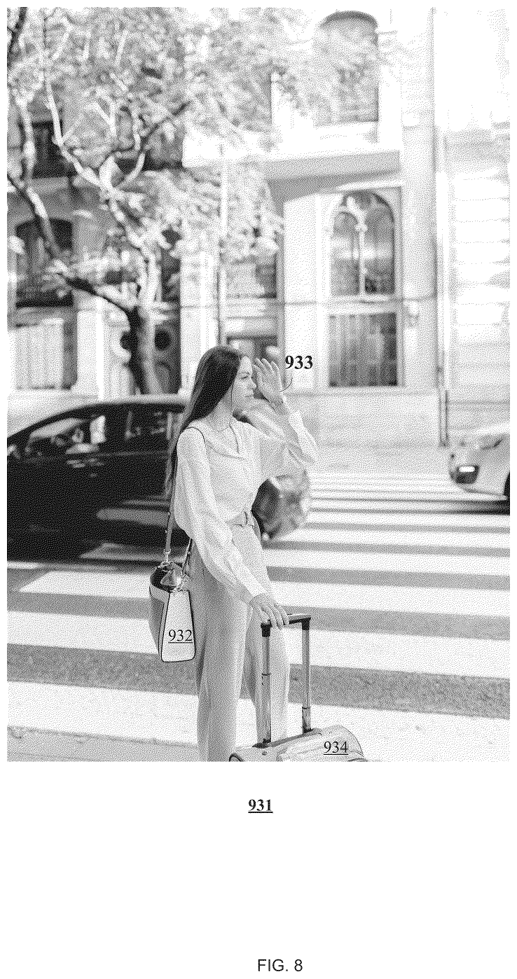

Image 931 of FIG. 8 illustrates a combination of a pedestrian 933 that is partially occluded by a bag 932 and carries a partially obscured suitcase 934. If this combination is deemed to be biased then artificially generated sensed information units that capture only the pedestrian or only the bag or only the suitcase may be generated.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any reference to a machine learning process should be applied mutatis mutandis to a neural network. Any reference to a neural network should be applied mutatis mutandis to a machine learning process.

Any combination of any module or unit listed in any of the figures, any part of the specification and/or any claims may be provided.

The vehicle may be any type of vehicle—such as a ground transportation vehicle, an airborne vehicle, or a water vessel.

The specification and/or drawings may refer to a sensed information unit. An image is an example of a sensed information unit. Any reference to an image may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a processor. The processor may be a processing circuitry (also referred to as a processing circuit). The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

The sensed information unit may be sensed by one or more sensors of one or more types. The one or more sensors may belong to the same device or system—or may belong to different devices of systems.

We claim:

1. A method of automatic bias related dataset creation for machine learning training, the method comprises:
identifying, via a self-supervised learning process, a sensed information unit that is classification biased as it exhibits a combination of features, the sensed information unit is of a dataset associated with captured data in a road environment;
automatically artificially creating a set of sensed information units exhibits only one or only some features of the combination of features; and
adding the automatically artificially created set to the dataset to provide an updated data set in association with the identified classification biased sensed information unit for training a machine learning process with the updated dataset to provide a trained machine learning process that identifies each of the combination of features as a separate feature for classification.

2. The method according to claim 1, wherein the combination of features capture a combination of a first element with a second element.

3. The method according to claim 2, wherein each of the automatically artificially created a set of sensed information units comprising at least one of: the first element, the second element, or a different combination of the first element and the second element.

4. The method according to claim 2, wherein the first element is at least a portion of a first road user, and the second element is at least a portion of a second road user.

5. The method according to claim 2, wherein the first element and the second element are at least a portion of a same road user.

6. The method according to claim 2, wherein the first element is captured with a first visual effect and the second element is captured with a second visual effect that differs from the first visual effect.

7. The method according to claim 1, wherein the combination of features involves different visual effects of a road user captured by the sensed information unit.

8. The method according to claim 1, wherein the combination of features involves partial occlusion, and an illumination feature of a road user captured by the sensed information unit.

9. The method according to claim 1, further comprising the training of the machine learning process with the updated dataset to provide the trained machine learning process that identifies each of the combination of features as the separate feature for classification.

10. The method according to claim 1, further comprises searching for outliers within sensed information units, and wherein the sensed information unit has a representation that is one of the outliers.

11. A non-transitory computer readable medium of automatic bias related dataset creation for machine learning training, the non-transitory computer readable medium stores instructions executable by a processing circuit for:
identifying, via a self-supervised learning process, a sensed information unit that is classification biased as it exhibits a combination of features, the sensed information unit is of a dataset associated with captured data in a road environment;
automatically artificially creating a set of sensed information units exhibits only one or only some features of the combination of features; and
adding the automatically artificially created set to the dataset to provide an updated data set in association with the identified classification biased sensed information unit for training a machine learning process with the updated dataset to provide a trained machine learning process that identifies each of the combination of features as a separate feature for classification.

12. The non-transitory computer readable medium according to claim 11, wherein the combination of features capture a combination of a first element with a second element.

13. The non-transitory computer readable medium according to claim 12, wherein each of the automatically artificially created a set of sensed information units comprising at least one of:
the first element, the second element, or a different combination of the first element and the second element.

14. The non-transitory computer readable medium according to claim 12, wherein the first element is at least a portion of a first road user, and the second element is at least a portion of a second road user.

15. The non-transitory computer readable medium according to claim 12, wherein the first element and the second element are at least a portion of a same road user.

16. The non-transitory computer readable medium according to claim 12, wherein the first element is captured with a first visual effect and the second element is captured with a second visual effect that differs from the first visual effect.

17. The non-transitory computer readable medium according to claim 11, wherein the combination of features involves different visual effects of a road user captured by the sensed information unit.

18. The non-transitory computer readable medium according to claim 11, wherein the combination of features involves partial occlusion, and an illumination feature of a road user captured by the sensed information unit.

19. The non-transitory computer readable medium according to claim 11, further storing instructions executable by the processing circuit for training of the machine learning process with the updated dataset to provide the trained machine learning process that identifies each of the combination of features as the separate feature for classification.

20. The non-transitory computer readable medium according to claim 11, further storing instructions executable by the processing circuit for searching for outliers within sensed information units, and wherein the sensed information unit has a representation that is one of the outliers.
